(19) United States
(12) Patent Application Publication
(10) Pub. No.: US 2019/0242808 A1
(43) Pub. Date: Aug. 8, 2019

(54) Corrosion Sensor

(71) Applicant: Well Diver, Inc., Stafford, TX (US)

(72) Inventors: Ting Chen, Missouri City, TX (US); Ram G. Shenoy, Katy, TX (US)

(73) Assignee: Well Diver, Inc., Stafford, TX (US)

(21) Appl. No.: 16/384,630

(22) Filed: Apr. 15, 2019

Related U.S. Application Data
(60) Provisional application No. 62/608,205, filed on Dec. 20, 2017.

(51) Int. Cl. G01N 17/04; E21B 41/02

(52) U.S. Cl. CPC G01N 17/046; E21B 41/02

(57) ABSTRACT

A corrosion sensor and ball are disclosed. The ball is sufficiently strong to withstand at least 10,000 psi of well pressure, yet is light enough to float in a well. The ball also includes a dissolvable weight heavy enough to cause the ball and corrosion sensor to sink in the well. Once the dissolvable weight dissolves, the ball and corrosion sensor float to the surface for easy retrieval and analysis. The rate of dissolution of the weight can be tailored to adjust the time it will take for the ball to return to the surface.

### CROSS-REFERENCE TO RELATED APPLICATIONS

This application claims priority to U.S. Provisional Patent Application No. 62/657,790 filed on Apr. 14, 2018 entitled RETRIEVABLE SENSOR PACKAGE TO ASSESS ENVIRONMENTAL EFFECTS ON MATERIALS AT TARGET ZONE IN WELLBORE which is incorporated herein by reference in its entirety.

### BACKGROUND

Catastrophic consequences may occur due to unexpected corrosion-related failures of metallic or non-metallic components used in the oil and gas when exposed to H2S rich production fluids. In almost all cases, materials selection for equipment manufacturers and completions design stems from, “Qualification based on laboratory testing”. This has been state of the art since 1975, without availability of any better mechanism to assess susceptibility of oilfield alloys, especially in live reservoir fluids at the production zone. There is a need in the art for a more reliable way to identify corrosion in a well.

### SUMMARY

Embodiments of the present disclosure are directed to a corrosion sensor including a sensor package carrier having an exterior surface and an interior volume, and a corrosion coupon being operatively coupled to the sensor package carrier and exposed to a well environment when the corrosion sensor is deployed in a well. The corrosion coupon is made of a material having known corrosion properties. The corrosion sensor also includes a sensor package carried by the sensor package carrier. The sensor package includes a sensing surface and an electronics module operatively coupled to the sensing surface and being configured to interpret signals from the sensing surface. The sensor package is sealed to the sensor package carrier with the electronics module being within the interior volume of the sensor package carrier. The sensor package carrier, corrosion coupon, and sensor package have a combined density that is less than a density of freshwater such that the sensor package carrier, corrosion coupon, and sensor package together are buoyant in freshwater. The corrosion sensor also includes a weight operatively coupled to the exterior surface sensor package carrier. The weight is designed to dissolve and release the weight from the sensor package carrier. The weight is sufficiently dense that a combined weight of the sensor package carrier, the sensor package, and the weight is more dense than freshwater such that the sensor package carrier, the sensor package, and the weight sinks in freshwater.

Further embodiments of the present disclosure are directed to a corrosion sensor including a ball comprising defining an interior volume and an exterior surface, the ball being able to withstand well pressure of at least 5,000 psi, and a corrosion coupon operatively coupled to the exterior surface such that the corrosion coupon is exposed to a well fluid when the ball is in a well. The ball and corrosion coupon together are buoyant in the well. The corrosion sensor also includes a dissolvable weight attached to the exterior surface, the weight being sufficiently heavy that when attached the ball, corrosion coupon, and dissolvable weight is sufficiently heavy to sink in the well. The dissolvable weight is designed to dissolve at a predetermined time and under predetermined well conditions. After dissolving sufficiently the ball with corrosion coupon is rendered buoyant in the well.

Still further embodiments of the present disclosure are directed to a method for measuring a corrosive environment in a well. The method includes placing a ball in a well, the ball including a corrosion coupon with a known corrosion profile and a dissolvable weight. The ball, corrosion coupon, and dissolvable weight together are heavy enough to sink in the well. Without the dissolvable weight the ball and corrosion coupon are buoyant in the well. The method also includes allowing the dissolvable weight to dissolve due to reactivity with well fluids, rendering the ball and corrosion coupon buoyant, allowing the ball and corrosion coupon to float toward a surface for retrieval, and analyzing the corrosion coupon against the corrosion profile to determine corrosive properties of the well.

### BRIEF DESCRIPTION OF THE FIGURES

FIG. 1 is a cross-sectional view of a sensor package carrier according to embodiments of the present disclosure.

FIG. 2 is an isometric view of the sensor package carrier.

FIG. 3 is a cross-sectional view of a sensor package carrier or ball according to further embodiments of the present disclosure.

FIG. 4 is an isometric view of the ball of FIG. 3.

FIG. 5 is a cross-sectional view of a ball according to embodiments of the present disclosure in which the ball includes coupons/weights shown in FIGS. 1 and 2 and the ring coupons/weights shown in FIGS. 3 and 4.

FIG. 6 is a cross-sectional view of a ball according to further embodiments of the present disclosure.

FIG. 7 is a cross-sectional illustration of a ball according to further embodiments of the present disclosure.

FIG. 8 is an isometric view of the ball of FIG. 7.

FIG. 9 is a cross-sectional view of a ball according to further embodiments of the present disclosure.

FIG. 10 is a cross-sectional view of a ball according to still further embodiments of the present disclosure including a potentiostat.

### DETAILED DESCRIPTION

Embodiments of the present disclosure are directed to a method and mechanism to intelligently assess environmental effects (corrosion, erosion and ECA) of metals, alloys, elastomers and other materials at target zone in wellbore for any time, extended or as needed. The present disclosure is also directed to engineering and integration of enablers novel nano-structured alloy and sensors capable of maintaining integrity under hostile environments and retrieval of pressure, temperature, pH, corrosion rates, erosion resistance, EAC susceptibility, corrosion images and other digital data after predetermined time exposure in a live reservoir at a significant cost benefit to operators compared to current autoclave testing.

Embodiments of the present disclosure are directed to a sensor package carrier, comprising a ball having an interior volume, an aperture, and a pressure/temperature sensor positioned in the interior volume of the ball. The pressure/temperature sensor has a sensing surface positioned in the aperture with the sensing surface exposed through the aperture. Corrosion instrument/probe is installed and sealed in the interior volume of the ball, measuring the corrosion data in-situ with pre-programmed software. The corrosion coupons are installed on the outside of the sensor package carrier, and are in physical contact with the corrosive environment (fluids and gases) in wellbore. The sensor package carrier is buoyant in water at atmospheric pressure, and it is capable of withstanding hydrostatic pressure of greater than 10,000 psi. The sensor package carrier is attached to dissolvable weights. After the weights dissolve, the sensor package carrier will flow back to the surface, carrying the exposed coupons back for further analysis. Such a sensor package carrier, or ball, is disclosed in U.S. patent application Ser. No. 15/953,445 filed on Jul. 24, 2018 entitled NESTED SENSOR GAUGE CARRIER HOUSED IN WATER REACTIVE OUTER SHELL FOR SMART ZONAL ISOLATION DEVICES which is incorporated herein in its entirety.

The general corrosion rates of corrosion coupons exposed in wellbore can be measured by weight loss method, electrical resistance (ER) technique or electrochemical measurements.

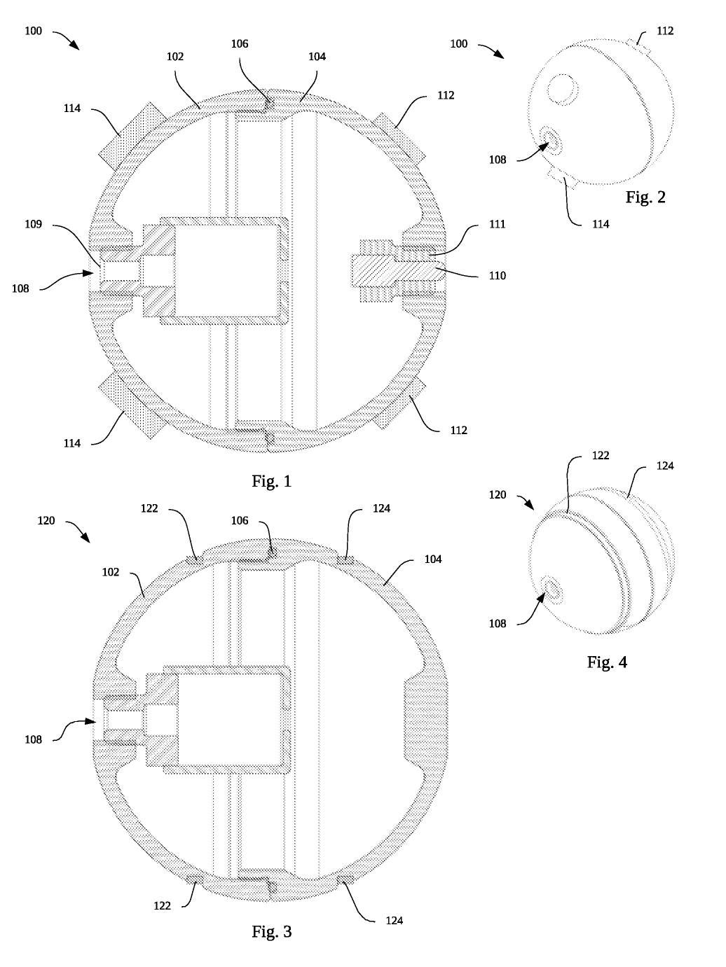

FIG. 1 is a cross-sectional view of a sensor package carrier 100 according to embodiments of the present disclosure. FIG. 2 is an isometric view of the sensor package carrier 100. The sensor package carrier 100 is also referred to herein as a ball for brevity. FIGS. 1 and 2 are referred to together. The ball 100 includes a first half 102 and a second half 104 that are joined together with a threadable joint and an O ring 106. The ball 100 includes a sensor 108 secured to the first half 102 such that pressure in the well acts on a sensing surface 109 and the data is recorded by the sensor 108. The ball 100 can also have a pH sensor 110 held to the second half 104 in a similar fashion by a housing 111. The ball 100 can withstand pressures of over 10,000 psi, and is buoyant in freshwater. The ball 100 can be pumped into a well or ran in hole in combination with other equipment to reach a desired depth, after which point it can be released and allowed to float to the surface for retrieval. The data can then be accessed easily.

In some embodiments the ball 100 also includes corrosion coupons 112 that are attached to an outer surface of the ball 100 and allowed to interact with the fluid in the well. The corrosion coupons can be any suitable size and shape and are designed from materials whose corrosion rates are well known. The ball 100 and coupons 112 can be therefore exposed to the wellbore fluid for a known time period after which the ball is retrieved and the coupons can be analyzed to determine how they have corroded. From the amount of corrosion that has affected the coupons, the corrosion rate of the well can be determined. The weight of the coupons is one way to check for corrosion through mass loss. The corrosion rate in terms of mm/y can be derived from the following equation:

$$R = 87.6 ( \frac{W}{DAT} )$$

Where R is the corrosion rate, 87.6 is a coefficient, W is weight loss in milligrams, D is metal density, A is the area of the corrosion coupon, and T is the time of exposure of the corrosion coupon. The coefficient can be a different number in other embodiments to adjust for various parameters including the material of the coupon. With this equation and the retrieved corrosion coupons, a very elegant technique for measuring actual corrosion in the well is achieved.

The ball can also include weights 114 that are attached to the ball 100 in one or more various locations. The weights 114 can be made of a dissolvable material and can be designed with sufficient weight to cause the ball 100 to sink. The ball 100 is therefore placed into the well with the weights and coupons attached, and after a known time period the weights dissolve, rendering the ball 100 buoyant at which point the ball 100 floats back to the surface. The characteristics of the weights 114 can be tailored closely to allow for a desired time period to pass before floating to the surface. In other embodiments a standard weight is used and the time between deployment and retrieval are recorded. All the data can be stored on the sensor 108 and corresponding electronics and memory on board.

Some embodiments of the ball 100 do not include a sensor at all; rather, the first half and second half of the ball 100 can be simple, spherical surfaces with nothing inside. For some applications that are focused on the corrosion aspect with no interest in a pressure, temperature, or pH reading, these sensors (one or both) can be omitted.

FIG. 3 is a cross-sectional view of a sensor package carrier or ball 120 according to further embodiments of the present disclosure. FIG. 4 is an isometric view of the ball 120 and will be addressed together with FIG. 3. The ball 120 includes features similar to the ball 100 shown in FIGS. 1 and 2, such as a first half 102, a second half 104, an O ring 106, and a sensor 108. The ball 120 in this embodiment includes a ring 122 that circles the ball 120. The ring 122 can be a weight made of a dissolvable material that operates in a similar manner to the weights shown in FIGS. 1 and 2. The ring 122 can entirely dissolve to render the ball 120 buoyant so that it floats upward in the well whereas before dissolving the weight causes the ball 120 to sink. In some embodiments the ring itself may or may not be dissolvable, but a connection to the ball is dissolvable such that when the connection dissolves the ring 122 dislodges from the ball 120 and permits the ball 120 to float. The placement of the ring 122 can vary as well. It is shown here to be parallel with the threaded connection at the hemisphere of the ball 120. In other embodiments the ring 122 can be nearer the pole of the ball, or nearer the hemisphere. The ball 120 can have indentations configured to receive the ring 122. There can be more than one ring 122 on the ball. The ring may be a C-ring that extends partway, but not entirely around the ball 120.

The ball 120 also includes a second ring 124 on the second half 104 of the ball 120. This ring can be a corrosion coupon that is designed to corrode at a known rate in a given well environment. The structure of the ring 124 and the placement of the ring 124 is similar to the ring 122. There can be any suitable number of rings on the ball, and any number of them can be weights and any number of them can be corrosion coupons.

FIG. 5 is a cross-sectional view of a ball 130 according to embodiments of the present disclosure in which the ball includes coupons/weights 132 shown in FIGS. 1 and 2 and the ring coupons/weights 134 shown in FIGS. 3 and 4.

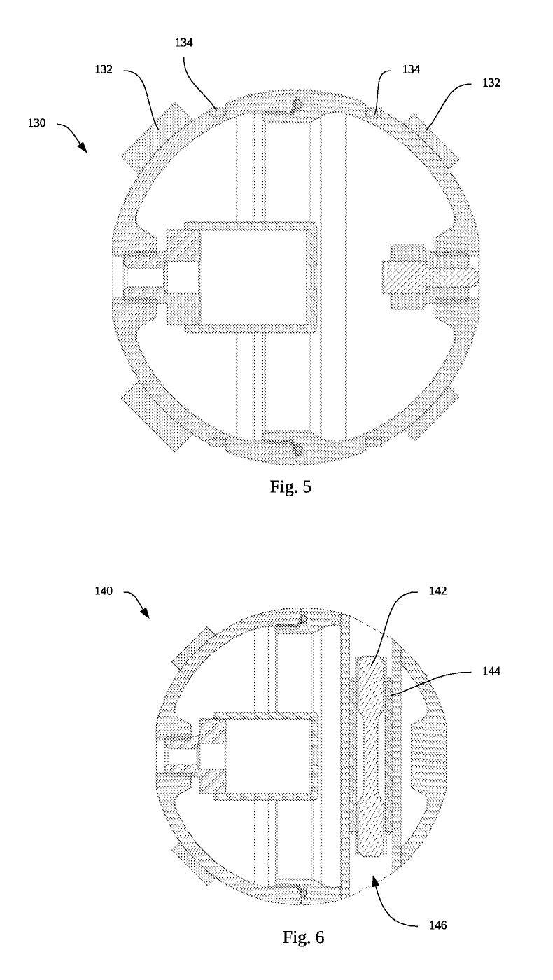

FIG. 6 is a cross-sectional view of a ball 140 according to further embodiments of the present disclosure. The ball 140 includes features shown and described hereinabove, and also shows a dogbone specimen according to embodiments of the present disclosure. The ball 140 includes a channel 146 that passes through (or partway through) the ball 140. A fastener 144 is secured to the channel 146, and a dogbone specimen 142 is secured to the fastener 144. Dog bone specimens are stressed to specified percentage (%) of their temperature de-rated yield strength in a load frame fixed to the inside of a tunnel exposed to wellbore fluids which in turn is placed in the interior of the ball. This allows reservoir fluids/gases to flow through and contact exposed specimens. The dog bone specimens may be stressed or non-stressed. Strain gauge (for example, a simple Wheatstone bridge) to measure time of fracture by recording strain data and corresponding relaxation due to failure on ASIC/Memory for ready reference. Any degradation or fracture of dog bone specimen after exposure can be detected examined after retrieval.

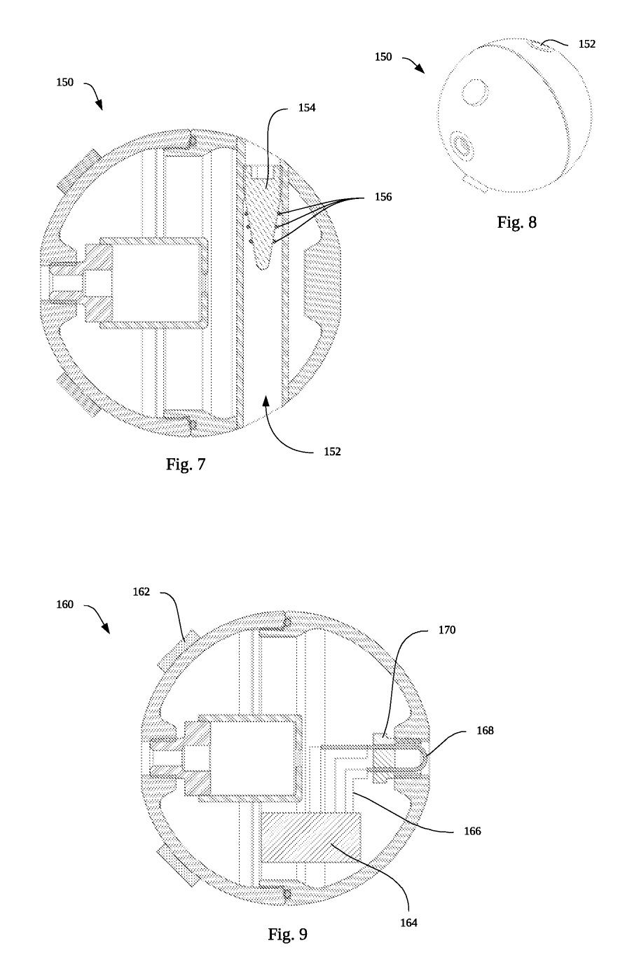

FIG. 7 is a cross-sectional illustration of a ball 150 according to further embodiments of the present disclosure. FIG. 8 is an isometric view of the ball 150. The ball 150 has a channel 152 that passes through the ball 150 in a manner generally similar to what was shown and described above with respect to FIG. 6. The ball 150 also includes a cone 154 inserted into the channel and fastened to the channel. The cone can be threaded and screwed into the channel or secured with other suitable means. The cone 154 can hold one or more O rings 156 at different heights to test the effect of a corrosive environment on the O rings at the different heights. The lower the O ring, the greater the lateral stretching. There can be any number of O rings tested and any condition of stretch can be tested as well. In other embodiments the cone 154 is replaced with a cylindrical or spherical shape to hold another sort of corrosion tester. The O rings can be made of any suitable material that is desired to be tested. In other embodiments the material is not to be tested, but rather serves as a corrosion indicator of a well environment. If the material of the O rings and the corrosion resistance of the O rings is known, then the ball 150 can be used to test the corrosive environment, which may be less well known. In some embodiments the channel 152 does not pass completely through the ball 150 and rather extends only partway through. In other embodiments there are multiple such channels each carrying cones and O rings.

FIG. 9 is a cross-sectional view of a ball 160 according to further embodiments of the present disclosure. The ball 160 includes weights 162 that can be dissolvable to render the ball 160 buoyant at a desired time. The ball 160 also includes an electronic unit 164, leads 166, and an electric resistance (ER) probe 168 that is coupled to the ball via a housing 170 that is threadably connected to the ball 160. The housing 170 can have a dielectric or other shielding on the threaded portion to avoid shorting through the ER probe 168. The ER of a material is given by:

$$R = r \cdot \frac{L}{A}$$

Where R is the resistance, r is the specific resistance of the probe, L is the element length, and A is the cross-sectional area. The values for R can be taken by the electronics unit 164 at various times and/or locations in the well. The corrosive properties of the probe 168 may be known ahead of time and can be used to map a corrosion profile of a well environment.

In some embodiments the electronics unit 164 can be programmed to begin recording data at a certain time. For example, data may be desired only after the dissolvable weights 162 have dissolved sufficiently to allow the ball 160 to float. The operation of the electronics unit 164 can be initiated as the weights 162 dissolve. In other embodiments the data can be recorded as the ball 160 is pumped down into the well, and recording can cease once the weights dissolve and the ball 160 begins to float. In still other embodiments the electronics unit 164 can record data constantly starting from the time the ball 160 is first dropped into the well until returning to the surface.

Reduction (metal loss) in the element's cross section due to corrosion is accompanied by a proportionate increase in the element's electrical resistance. The tested metal or alloy element is freely exposed in the corrosive environment, and a reference element and a probe/instrument can be sealed within the sensor package carrier. The resistance ratio of the exposed element to the reference element is measured. Any net change in the resistance ratio is attributed to the weight loss from the exposed element. Sensing elements can be manufactured in a variety of geometric configurations (wire loop, cylindrical, spiral loop, tube loop, strip loop, flush, etc.).

When measuring ER, the instrument produces a linearized signal that is proportional to the exposed element's total metal loss. The true numerical value being a function of the element thickness and geometry. In calculating M, these geometric and dimensional factors are incorporated into the probe life, and the metal loss is given by:

$$M = S \cdot \frac{P}{1000}$$

Corrosion rate is then derived by:

$$C = P \cdot \frac{365 ( {S}_{2} - {S}_{1} )}{1000 Δ T}$$

Where M is the exposed element's total metal loss, S is the linearized signal, P is the probe life, and ΔT is the time lapse in days between instrument readings S₁ and S₂.

Corrosion occurs by an electrochemical reaction, in which an anode (positive electrode) is oxidized (losses electrons) and a cathode (negative electrode) is chemically reduced (received electrons). Therefore, it is possible to evaluate corrosion characteristics and corrosion behavior by performing an electrochemical test and measuring the characteristic values. Electrochemical measurement is one effective analytical technique for corrosion investigation. Electrochemical techniques such as open circuit potential (OCP), linear polarization resistance (LPR), potentiodynamic polarization, and electrochemical impedance spectroscopy (EIS), can be carried out to measure electrochemical parameters (corrosion potential, polarization resistance, corrosion current density, pitting potential, electrochemical impedance, etc.) to determine the corrosion performance of materials.

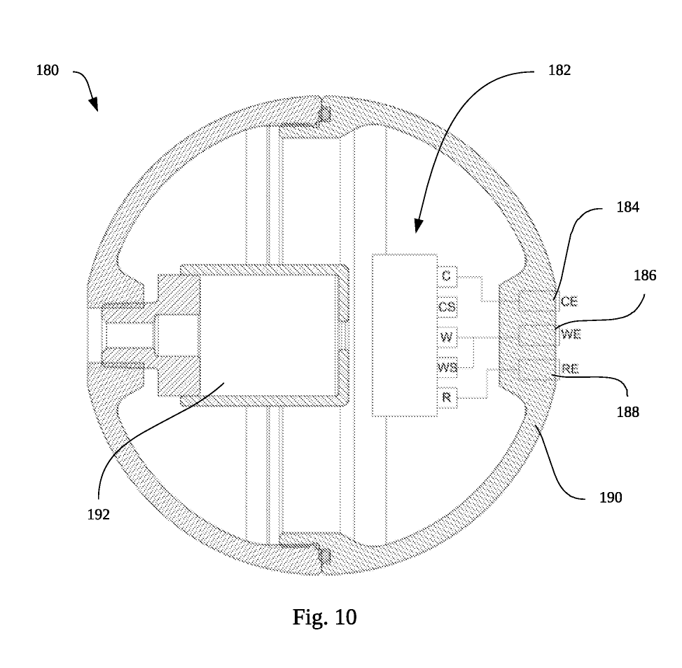

FIG. 10 is a cross-sectional view of a ball 180 according to still further embodiments of the present disclosure including a potentiostat 182. Corrosion occurs by an electrochemical reaction, in which an anode (positive electrode) is oxidized (losses electrons) and a cathode (negative electrode) is chemically reduced (received electrons). Therefore, it is possible to evaluate corrosion characteristics and corrosion behavior by performing an electrochemical test and measuring the characteristic values. Electrochemical measurement is one effective analytical technique for corrosion investigation. Electrochemical techniques such as open circuit potential (OCP), linear polarization resistance (LPR), potentiodynamic polarization, and electrochemical impedance spectroscopy (EIS), can be carried out to measure electrochemical parameters (corrosion potential, polarization resistance, corrosion current density, pitting potential, electrochemical impedance, etc.) to determine the corrosion performance of materials.

The potentiostat 182 includes a three-electrode cell: a counter electrode 184, a working electrode 186, and a reference electrode 188. The housing 190 can include sufficient dielectric or other suitable insulation to prevent a short between the electrodes. Working and counter carry the current, and working sense and reference are sense leads which measure potential. It can be setup to run 2-electrode, 3-electrode or 4-electrode measurements. Working electrode 186 is the designation for the material to be tested. The counter electrode 184 is the one in the cell that completes the current path, and is made of a relatively inert material. The reference electrode 188 serves as a reference point for the potential measurement. It can hold a constant potential and have little or no current flow through them during test. The potentiostat 182 can be configured to contain sufficient electronics and memory to store data pertaining to the results of the tests that can be mapped to a corrosion profile for a well. In some embodiments the ball 180 includes a sensor 190 that can be a pressure, temperature, and/or pH sensor, holds the memory and is configured to communicate with the potentiostat 182 to record the data. Although not shown, the embodiments of FIG. 10 can also include weights that can dissolve to render the ball 180 buoyant.

The sensor package carriers shown and described herein can be placed into a well in the fluid entering the well and can be allowed to float or sink freely within the well. In some embodiments the sensor package carriers can be fastened to a portion of a completion, a valve, a liner hanger, or another portion of the well that is run into the well during normal completion activities. The fastening can be achieved using a dissolvable material that is configured to dissolve at a known rate. The rate of dissolution can be tailored to adjust the time the sensor package carrier will spend at depth in the well, after which the buoyancy of the sensor package carrier will cause it to float to the surface so that data can be read.

The foregoing disclosure hereby enables a person of ordinary skill in the art to make and use the disclosed systems without undue experimentation. Certain examples are given to for purposes of explanation and are not given in a limiting manner.

1. A corrosion sensor, comprising:
a sensor package carrier having an exterior surface and an interior volume;
a corrosion coupon being operatively coupled to the sensor package carrier and exposed to a well environment when the corrosion sensor is deployed in a well, the corrosion coupon being made of a material having known corrosion properties;
a sensor package carried by the sensor package carrier, the sensor package comprising a sensing surface and an electronics module operatively coupled to the sensing surface and being configured to interpret signals from the sensing surface, the sensor package being sealed to the sensor package carrier with the electronics module being within the interior volume of the sensor package carrier, the sensor package carrier, corrosion coupon, and sensor package having a combined density that is less than a density of freshwater such that the sensor package carrier, corrosion coupon, and sensor package together are buoyant in freshwater; and
a weight operatively coupled to the exterior surface sensor package carrier, the weight being configured to dissolve and release the weight from the sensor package carrier, wherein the weight is sufficiently dense that a combined weight of the sensor package carrier, the sensor package, and the weight is more dense than freshwater such that the sensor package carrier, the sensor package, and the weight sinks in freshwater.

2. The corrosion sensor of claim 1 wherein the corrosion coupon comprises a button coupon.

3. The corrosion sensor of claim 1 wherein the corrosion coupon is a ring that circumscribes at least a portion of the sensor package carrier.

4. The corrosion sensor of claim 3 wherein the sensor package carrier comprises a ball having two hemispheres joined at an equatorial line, wherein the ring is parallel to and displace axially from the equatorial line.

5. The corrosion sensor of claim 1 wherein the corrosion coupon comprises an electrically resistive probe.

6. The corrosion sensor of claim 1 wherein the corrosion coupon comprises a potentiostat comprising a working electrode, a counter electrode, and a reference electrode.

7. The corrosion sensor of claim 1 wherein the exterior surface of the sensor package carrier comprises a channel passing at least partway through the sensor package carrier.

8. The corrosion sensor of claim 7 wherein the corrosion coupon comprises a dogbone positioned in the channel.

9. The corrosion sensor of claim 7 wherein the corrosion coupon comprises an O ring coupled to a cone, wherein the cone is fastened in the channel.

10. The corrosion sensor of claim 1 wherein the sensing surface is configured to measure at least one of pressure, temperature, and ph.

11. The corrosion sensor of claim 1 wherein the sensor package carrier is configured to withstand at least 10,000 psi of fluid hydrostatic pressure.

12. The corrosion sensor of claim 1 wherein the weight comprises a fastener configured to secure the corrosion sensor to a completion component that is installed in the well.

13. The corrosion sensor of claim 1 wherein the weight has a dissolution rate chosen according to a desired length of time for the corrosion coupon to interact with the well environment.

14. A corrosion sensor, comprising:
a ball comprising defining an interior volume and an exterior surface, the ball being able to withstand well pressure of at least 5,000 psi;
a corrosion coupon operatively coupled to the exterior surface such that the corrosion coupon is exposed to a well fluid when the ball is in a well, the ball and corrosion coupon together being buoyant in the well;
a dissolvable weight attached to the exterior surface, the weight being sufficiently heavy that when attached the ball, corrosion coupon, and dissolvable weight is sufficiently heavy to sink in the well, wherein the dissolvable weight is configured to dissolve at a predetermined time and under predetermined well conditions, and wherein after dissolving sufficiently the ball with corrosion coupon is rendered buoyant in the well.

15. The corrosion sensor of claim 14 wherein the ball is sufficiently strong to withstand well pressure of at least 10,000 psi.

16. The corrosion sensor of claim 14 wherein the interior volume is hollow and contains a sensor configured to measure at least one of pressure, temperature, and pH in the well.

17. The corrosion sensor of claim 14 wherein the corrosion coupon comprises a button coupon.

18. The corrosion sensor of claim 14 wherein the corrosion coupon comprises a ring attached to the exterior surface.

19. The corrosion sensor of claim 14 wherein the corrosion coupon comprises a dogbone assembly.

20. The corrosion sensor of claim 14 wherein the exterior surface comprises a channel passing at least partway through the ball.

21. The corrosion sensor of claim 14 wherein the corrosion coupon comprises a resistance sensor and corresponding electronics, wherein a resistance of the resistance sensor is measured for change caused by a corrosive environment in the well.

22. A method for measuring a corrosive environment in a well, the method comprising:
placing a ball in a well, the ball including a corrosion coupon with a known corrosion profile and a dissolvable weight, wherein the ball, corrosion coupon, and dissolvable weight together are heavy enough to sink in the well, and wherein without the dissolvable weight the ball and corrosion coupon are buoyant in the well;
allowing the dissolvable weight to dissolve due to reactivity with well fluids, rendering the ball and corrosion coupon buoyant;
allowing the ball and corrosion coupon to float toward a surface for retrieval; and
analyzing the corrosion coupon against the corrosion profile to determine corrosive properties of the well.

23. The method of claim 22 wherein the ball further comprises a sensor configured to measure at least one of pressure, temperature, and pH of the well, the method further comprising measuring at least one of pressure, temperature, and pH of the well.

24. The method of claim 22 wherein the dissolvable weight comprises an attachment configured to secure the ball to a completion component in the well, and wherein allowing the dissolvable weight to dissolve comprises severing an attachment to the completion component in the well to allow the ball to float toward the surface.
